(19) United States
(12) Patent Application Publication
(10) Pub. No.: US 2008/0007505 A1
(43) Pub. Date: Jan. 10, 2008

(54) DRIVING APPARATUS, LIQUID CRYSTAL DISPLAY COMPRISING THE DRIVING APPARATUS AND METHOD OF DRIVING THE LIQUID CRYSTAL DISPLAY

(76) Inventors: Ho-young Kim, Seoul (KR); Hyeon-seok Bae, Seoul (KR)

Correspondence Address: Frank Chau, Esq.;F. CHAU & ASSOCIATES, LLC, 130 Woodbury Road, Woodbury, NY, 11797, US

(21) Appl. No.: 11/694,018

(22) Filed: Mar. 30, 2007

(30) Foreign Application Priority Data
Jul. 7, 2006 (KR) 10-2006-0064000

(51) Int. Cl. G09G 3/36

(52) U.S. Cl. 345/90; 345/87

(57) ABSTRACT

A driving apparatus includes a timing controller, a gate driver, and a pulse width controller. The timing controller generates a gate output enable signal having a width which is used for defining on-voltage widths of gate driving signals. The gate driver sequentially outputs the gate driving signals corresponds to a plurality of gate lines. The gate driver is controlled to prevent overlapping of the gate driving signals. The pulse width controller includes a signal generator and a converter. The signal generator receives two of the gate driving signals from two adjacent gate lines, compares the two gate driving signals, and generates a detection signal that detects an overlapping area of the two gate driving signals. The converter converts the detection signal to a pulse width control signal and feeds the pulse width control signal back to the timing controller. The timing controller receives the pulse width control signal and adjusts the width of the gate output enable signal.

### CROSS-REFERENCE TO RELATED APPLICATION

This application claims priority to Korean Patent Application No. 10-2006-0064000 filed on Jul. 7, 2006, in the Korean Intellectual Property Office, the disclosure of which is incorporated by reference herein.

### BACKGROUND OF THE INVENTION

1. Technical Field

The present disclosure relates to a driving apparatus, a liquid crystal display having the same and a method of driving the liquid crystal display, and more particularly, to a driving apparatus which can enhance the display quality of the liquid crystal display by implementing an optimal gate output enable signal, a liquid crystal display having the driving apparatus and a method of driving the liquid crystal display having the driving apparatus.

2. Discussion of the Related Art

The application of liquid crystal displays as a means of display has become widespread in various industries. Generally, liquid crystal displays includes two substrates on which a plurality of electrodes are formed and a liquid crystal layer interposed therebetween. The transmittance of incident light is controlled by applying an electric field generated by voltages applied to the electrodes, which rearranges liquid crystal molecules of the liquid crystal layer in a predetermined direction to display a desired image.

A liquid crystal display typically includes a plurality of gate lines extending in parallel with each other and a plurality of data lines insulated from and extending perpendicular to the gate lines. Pixels are formed at the intersecting areas of the plurality of gate lines and the plurality of data lines. Each pixel has a thin film transistor (TFT) at the intersection of each gate line and each data line.

Gate driving signals, e.g., gate-on and/or gate-off voltages, are sequentially applied to the gate lines of the liquid crystal display. The gate driving signals are supplied to the gate lines through a gate driver disposed at one side of a liquid display panel. During the transmission of the gate driving signals from one side of the liquid display panel to the other side, an RC delay caused by the resistance and capacitance of the gate lines and the liquid display panel may occur. Thus, the gate driving signals, supplied to the respective gates lines of the liquid display panel along two adjacent gate lines of the liquid display panel, overlap each other at a predetermined area on the same time axis due to the RC delay. For this reason, interference may be generated between the two adjacent gate lines, which simultaneously turns on the TFTs connected to the respective gate lines, resulting in a switching error which deteriorates the display quality of the liquid crystal display.

### SUMMARY OF THE INVENTION

According to an exemplary embodiment of the present invention, there is provided a driving apparatus which includes a timing controller, a gate controller, and a pulse width controller. The timing controller generates a gate output enable signal having a width which is used for defining on-voltage widths of gate driving signals. The gate driver sequentially outputs the gate driving signals corresponding to a plurality of gate lines. The gate driver is controlled to prevent overlapping of the gate driving signals. The pulse width controller includes a signal generator and a converter. The signal generator receives two of the gate driving signals from two adjacent gate lines, compares the two gate driving signals and generates a detection signal that detects an overlapping area of the two gate driving signals. The converter converts the detection signal to a pulse width control signal and feeds the pulse width control signal back to the timing controller. The timing controller receives the pulse width control signal and adjusts the width of the gate output enable signal.

According to an exemplary embodiment of the present invention, there is provided a liquid crystal display including a liquid crystal panel, a timing controller, a gate driver, and a pulse width controller. The liquid crystal display has a plurality of gate lines and a plurality of data lines intersecting with each other. The timing controller generates a gate output enable signal having a width for defining on-voltage widths of gate driving signals. The gate driver sequentially outputs the gate driving signals corresponding to the plurality of gate lines. The gate driver is controlled to prevent overlapping of the gate driving signals. The pulse width controller includes a signal generator and a converter. The signal generator receives two of the gate driving signals from two adjacent gate lines, compares the two gate driving signals and generates a detection signal that detects an overlapping area of the two gate driving signals. The converter converts the detection signal to a pulse width control signal and feeds the pulse width control signal back to the timing controller. The timing controller receives the pulse width control signal and adjusts the width of the gate output enable signal.

According to an exemplary embodiment of the present invention, there is provided a method of driving a liquid crystal display. The method includes the steps of generating a gate output enable signal having a width which is used for defining on-voltage widths of gate driving signals, sequentially outputting the gate driving signals corresponding to a plurality of gate lines, the outputting of the gate driving signal being controlled to prevent overlapping of the gate driving signals, receiving two of the gate driving signals from two adjacent gate lines and generating a pulse width control signal by detecting an overlapping area of the two gate driving signals, and adjusting the width of the gate output enable signal based on the pulse width control signal.

### BRIEF DESCRIPTION OF THE DRAWINGS

The above and other features of the present invention will become more apparent by describing in detail exemplary embodiments thereof with reference to the attached drawings, in which:

FIG. 1 is a block diagram of a liquid crystal display, according to an exemplary embodiment of the present invention;

FIG. 2 is an equivalent circuit diagram of a pixel in a liquid crystal display, according to an exemplary embodiment of the present invention;

FIG. 3 is a block diagram of a pulse width controller of FIG. 1, according to an exemplary embodiment of the present invention;

FIG. 4 is a circuit diagram of a signal generator of FIG. 3, according to an exemplary embodiment of the present invention;

FIG. 5 is a diagram illustrating waveforms of various signals shown in FIG. 4;

FIG. 6 is a diagram illustrating waveforms of various signals produced by the operation of a timing generator of FIG. 1;

FIG. 7 is a block diagram of a liquid crystal display, according to an exemplary embodiment of the present invention; and

FIG. 8 is a block diagram of a liquid crystal display, according to an exemplary embodiment of the present invention.

### DETAILED DESCRIPTION OF EXEMPLARY EMBODIMENTS

Hereinafter, exemplary embodiments of the present invention will now be described more fully with reference to the accompanying drawings. Like reference numerals refer to like elements throughout the specification.

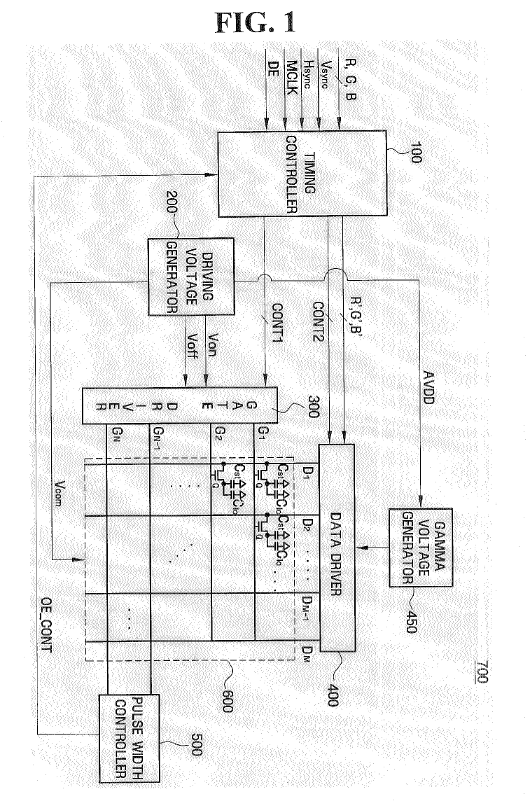

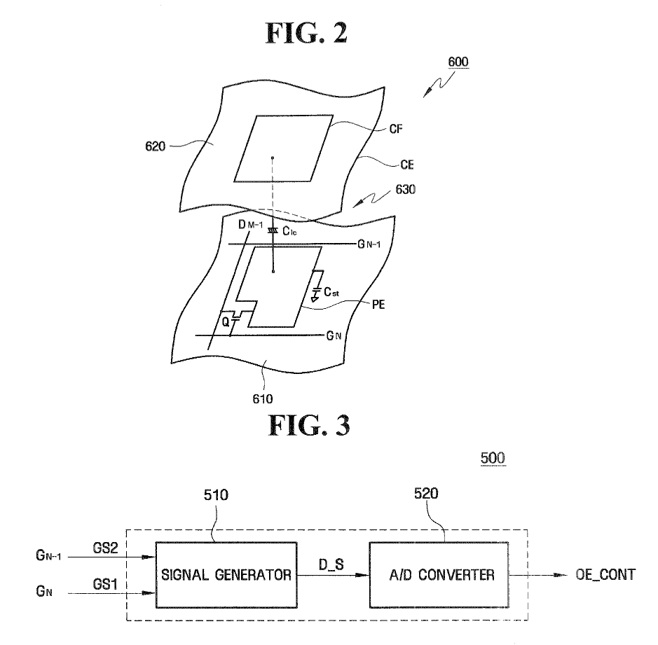

FIG. 1 is a block diagram of a liquid crystal display, according to an exemplary embodiment of the present invention, FIG. 2 is an equivalent circuit diagram of a pixel in a liquid crystal display, according to an exemplary embodiment of the present invention, and FIG. 3 is a block diagram of a pulse width controller of FIG. 1, according to an exemplary embodiment of the present invention.

Referring first to FIG. 1, the liquid crystal display 700 includes a liquid display panel 600, and driving apparatuses 100, 200, 300, 400, 450, and 500. The driving apparatuses 100, 200, 300, 400, 450 and 500 include a timing controller 100, a driving voltage generator 200, a gate driver 300, a data driver 400, a gamma voltage generator 450, and a pulse width controller 500.

As shown in FIG. 1, the liquid crystal panel 600 includes a plurality of unit pixels including a plurality of display signal lines G₁-G_{N} and D₁-D_{M} arranged substantially in a matrix.

The plurality of display signal lines G₁-G_{N} and D₁-D_{M} include a plurality of gate lines G₁-G_{N} transmitting gate signals to the liquid crystal panel 600 and a plurality of data lines D₁-D_{M} transmitting data signals to the liquid crystal panel 600. The gate lines G₁-G_{N} extend substantially in a row direction on the liquid crystal panel 600 and are substantially parallel to each other, while the data lines D₁-D_{M} extend substantially in a column direction on the liquid crystal panel 600 and are substantially parallel to each other.

At least two adjacent gate lines among the plurality of gate lines G₁-G_{N} may extend in a direction in which the gate driving signals are transmitted. The Nth gate line G_{N} disposed at the lowermost end of the liquid crystal panel 600 and the (N−1)th gate line G_{N-1}, which is adjacent to the Nth gate line G_{N}, for example, may each extend at a predetermined length in a direction in which the gate driving signals are transmitted. The extended portions of the Nth gate line G_{N} and the (N−1)th gate line G_{N-1} may be connected to inputs of the pulse width controller 500. The Nth gate line G_{N} and the (N−1)th gate line G_{N-1} may be disposed substantially in parallel with the outermost data line, for example, the Mth data line D_{M}, along one side of the liquid crystal panel 600.

The Nth gate line G_{N} and the (N−1)th gate line G_{N-1} disposed along one side of the liquid crystal panel 600 may be connected to the inputs of the pulse width controller 500 through the data driver 400.

Each of the plurality of pixels comprises a switching element Q connected to a corresponding one of the plurality of display signal lines G₁-G_{N} and D₁-D_{M}, a liquid crystal capacitor C_{lc} and a storage capacitor Cₛₜ connected to the switching element Q. The storage capacitor Cₛₜ is optional.

Referring to FIG. 2, the liquid crystal panel 600 includes a first substrate 610, a second substrate 620 facing the first substrate 610, and a liquid crystal layer 630 interposed between the first substrate 610 and the second substrate 620. The first substrate 610 includes a plurality of gate lines (G_{N}, G_{N-1}), a data line D_{M} intersecting the plurality of gate lines (G_{N}, G_{N-1}), a switching element Q, and a pixel electrode (PE). The second substrate 620 includes a common electrode (CE) corresponding to the pixel electrode PE of the first substrate 610, and a color filter (CF).

The switching element Q is a two-terminal element having the pixel electrode PE of the first substrate 610 and the common electrode CE of the second substrate 620. The crystal layer 630 interposed between the pixel electrode PE and the common electrode CE serves as an insulator. The pixel electrode PE is connected to the switching element Q, and a common voltage is applied to the common electrode CE formed on the front face of the second substrate 620. The common electrode CE may also be formed on the first substrate 610. When the common electrode CE is formed on the first substrate 610, the pixel electrode PE and the common electrode CE may be shaped as lines or strips.

The storage capacitor Cₛₜ has a separate signal line (not shown) overlapping the pixel electrode PE and provided on the first substrate 610. A predetermined voltage, e.g., the common voltage Vcom, is applied to the signal line, which is known as a separate wire method. Alternatively, the storage capacitor Cₛₜ may have a previous gate line overlapping the pixel electrode PE via an insulator, which is known as a previous gate method.

For a color display, each pixel uniquely represents one of three primary colors such as red, green and blue colors, thereby obtaining a desired color. Each pixel includes a color filter CF representing one of the three primary colors in an area of the first substrate 610. The color filter CF may be provided on or under the pixel electrode PE of the first substrate 610.

A polarizer (not shown) for polarizing light is attached to the outer surface of at least one of the first and second substrates 610 and 620 of the liquid crystal panel 600.

To provide the driving signals and the control signals to the liquid crystal panel 600, the liquid crystal display 700 includes various driving apparatuses, such as the timing controller 100, the driving voltage generator 200, the gate driver 300, the data driver 400, the gamma voltage generator 450, and the pulse width controller 500.

The timing controller 100 receives predetermined signals from an external device (not shown), generates signals for controlling operations of the gate driver 300 and the data driver 400, and sends the corresponding control signals to the gate driver 300 and the data driver 400.

In addition, the timing controller 100 processes externally applied R, G, B image signals in a suitable manner for the operation of the liquid crystal panel 600 and provides its processed image signals to the data driver 400 as data driving signals.

The driving voltage generator 200 generates various driving voltages and provides the generated driving voltages to the gate driver 300 and the liquid crystal panel 600. Examples of the driving voltages include a gate-on voltage Von, a gate-off voltage Voff, and a common voltage Vcom.

The gate driver 300 is connected to a plurality of gate lines G₁-G_{N} of the liquid crystal panel 600 and provides the driving voltages to the gate lines G₁-G_{N}. The driving voltages include a gate on-voltage Von and a gate-off voltage Voff.

The data driver 400 is connected to a plurality of data lines D₁-D_{M} of the liquid crystal panel 600, generates a plurality of gray voltages based on a plurality of gamma voltages supplied from the gamma voltage generator 450, and selects the generated gray voltages to apply the selected gray voltages to a unit pixel as data driving signals. The data driver 400 may be composed of a plurality of integrated circuits.

The gate driver 300 or the data driver 400 may be mounted on the liquid crystal panel 600 as a plurality of driving IC chips. Alternatively, the gate driver 300 or the data driver 400 may be mounted on a flexible printed circuit (“FPC”) film and then attached to the liquid crystal panel 600 in the form of a tape carrier package (“TCP”). Alternatively, the gate driver 300 or the data driver 400 may be integrated on the liquid crystal panel 600 together with display signal lines including the gate lines G₁-G_{N} and the data lines D₁-D_{M}, and the switching element Q.

The gamma voltage generator 450 generates two sets of a plurality gamma voltages associated with transmittance of the unit pixel. A first set of the plurality gamma voltages has a positive polarity with respect to the common voltage Vcom while a second set has a negative polarity with respect to the common voltage Vcom. The positive-polarity gamma voltages and negative-polarity gamma voltages are alternatively supplied to the liquid crystal panel 600 during inversion driving.

The pulse width controller 500 is connected to at least two adjacent gate lines among the gate lines G₁-G_{N}, generates a predetermined signal OE_CONT and feeds the generated signal OE_CONT back to the timing controller 100. The pulse width controller 500 is connected to, for example, the lowermost gate line, i.e., the Nth gate line G_{N}, and its adjacent gate line, i.e., the (N−1)th gate line G_{N-1}, generates a predetermined signal OE_CONT and feeds the same back to the timing controller 100.

The driving apparatuses 100, 200, 300, 400, 450 and 500 receive externally applied driving and control signals and appropriately process the signals and provide the processed signals to the liquid crystal panel 600 as driving and control signals.

The timing controller 100 is supplied from an external graphic controller (not shown) with RGB image signals R, G and B and input control signals controlling the display thereof, for example, a vertical synchronization signal V_{sync}, a horizontal synchronization signal H_{sync}, a main clock MCLK, a data enable signal DE, etc.

The timing controller 100 generates gate control signals CONT1 and data control signals CONT2 and processes the input image signals R, G and B according to the operation condition of the liquid crystal panel 600 on the basis of the input control signals.

The gate control signals CONT1 generated from the timing controller 100 are provided to the gate driver 300, and the data control signals CONT2 and the processed image signals R′, G′ and B′ are provided to the data driver 400.

The gate control signals CONT1 include a vertical start signal STV indicating the start of vertical scanning of a gate-on pulse (a period of a gate-on voltage), a gate clock signal CPV for controlling the output time of a gate-on voltage Von and an output enable signal OE for defining the width of a gate-on voltage Von, i.e., a gate driving voltage.

The data control signals CONT2 include a horizontal start signal STH indicating the start of a horizontal period, a load signal LOAD for instructing application of the appropriate data voltages to the respective data lines D₁-D_{M}, an inversion control signal RVS for reversing the polarity of the data voltages (with respect to the common voltage V_{com}), and a data clock signal HCLK.

The timing controller 100 adjusts the width of the output enable signal OE based on the pulse width control signal OE_CONT fed back from the pulse width controller 500, and controls widths of gate-on pulses, i.e., gate driving signals, so as not to overlap with each other.

The data driver 400 sequentially receives image signals R′, G′ and B′ corresponding to one row of the liquid crystal panel 600 responsive to the data control signals CONT2 which is supplied from the timing controller 100, selects gray voltages corresponding to the respective image signals R′, G′ and B′ and converts the image signals R′, G′ and B′ into data driving voltages, respectively.

The gate driver 300, which is connected to the gate lines G₁-G_{N} of the liquid crystal panel 600, sequentially applies gate-ON voltages Von supplied from the timing controller 100, i.e., gate driving voltages having pulse widths modulated to be controlled so as to avoid overlapping with each other, to the gate lines G₁-G_{N} and turns on the switching elements Q connected to the gate lines G₁-G_{N}.

The data driver 400 applies the data voltages to the corresponding data lines D₁-D_{M} of the liquid crystal panel 600 during a turn-on time of the switching elements Q connected to one among the gate lines G₁-G_{N} as the gate-on voltages Von are applied thereto. The turn-on time is called “one horizontal period” or “1H” and equals one period of the horizontal synchronization signal H_{sync} and the data enable signal DE.

The pulse width controller 500 receives gate driving signals from two adjacent gate lines among the gate lines G₁-G_{N}. For example, the pulse width controller 500 receives two gate driving signals through the lowermost Nth gate line G_{N}, and the (N−1)th gate line G_{N-1}, which is adjacent to the Nth gate line G_{N}.

In addition, the pulse width controller 500 detects an overlapping area of the two gate driving signals and generates a predetermined control signal, e.g., the pulse width control signal OE_CONT. The pulse width controller 500 generates the pulse width control signal OE_CONT by detecting a pulse width signal of an area where the gate driving signals are both at a logic high state on a same time axis. The generated pulse width control signal OE_CONT is fed back to the timing controller 100. The timing controller 100 adjusts the width of the gate output enable signal OE based on the pulse width control signal OE_CONT and defines the widths of the gate driving signals.

The pulse width controller 500 generates the pulse width control signal OE_CONT such that it operates at least once while the gate driving signals are sequentially applied to all of the gate lines G₁-G_{N} of the liquid crystal panel 600 during a period of a frame to apply the data driving signals to all of the pixels. The pulse width control signal OE_CONT is also applied to the operation of a next frame of the liquid crystal panel 600, thereby defining the widths of the gate driving signals supplied to the liquid crystal panel 600.

The pulse width controller 500 will now be described in more detail with reference to FIGS. 3 through 5.

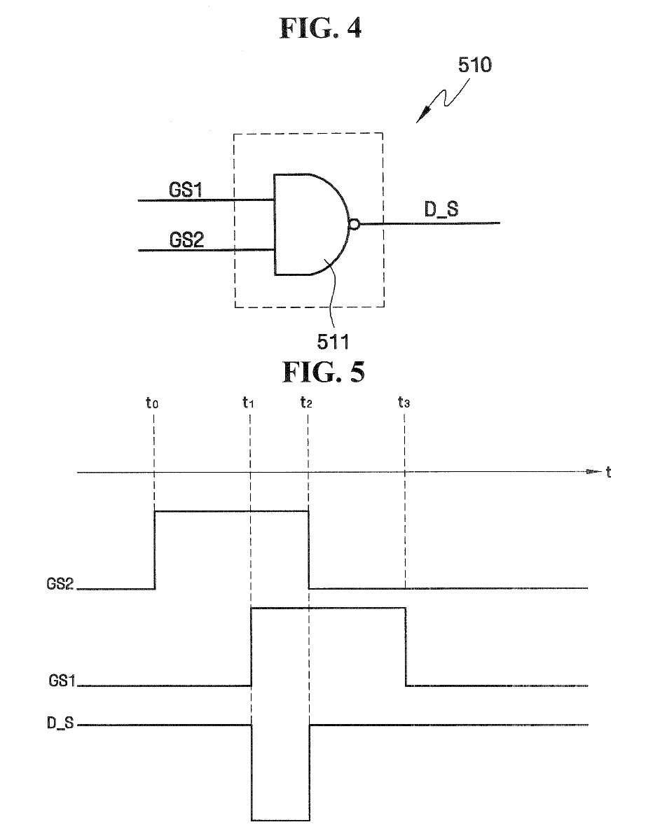

FIG. 3 is a block diagram of the pulse width controller 500 of FIG. 1, according to an exemplary embodiment of the present invention, FIG. 4 is a circuit diagram of a signal generator (510) of FIG. 3, according to an exemplary embodiment of the present invention, and FIG. 5 is a diagram illustrating waveforms of various signals shown in FIG. 4.

Referring first to FIG. 3, together with FIG. 1, the pulse width controller 500 includes a signal generator 510 and an analog-to-digital (A/D) converter 520.

The signal generator 510 receives gate driving signals GS₁ and GS₂ from two adjacent gate lines of the liquid crystal panel 600. The gate driving signals GS₁ and GS₂ may be a first gate driving signal GS₁ and a second gate driving signal GS₂, which are input to the signal generator 510 through two adjacent gate lines among the gate lines G₁-G_{N} of the liquid crystal panel 600, for example, the Nth gate line G_{N} disposed at a lowermost end of the liquid crystal display, and the (N−1)th gate line G_{N-1}, which is adjacent to the Nth gate line G_{N}.

In addition, the signal generator 510 detects an overlapping turn-on pulse area of the two input gate driving signals, i.e., the first and second gate driving signals GS₁ and GS₂, and generates a predetermined detection signal D_S. For example, the signal generator 510 may generate the detection signal D_S by detecting an area where the first and second gate driving signals GS₁ and GS₂ are both at a logic high state on the same time axis.

The operation of the signal generator 510 will now be described in more detail with reference to FIGS. 4 and 5.

Referring to FIG. 4, together with FIG. 3, the signal generator 510 may be implemented as a logic circuit including a NAND gate 511. The signal generator 510 receives the gate driving signals GS₁ and GS₂ from two adjacent gate lines of the liquid crystal panel 600 and generates the detection signal D_S. The first gate driving signal GS₁ is applied to an input terminal of the signal generator 510, i.e., a first input of the NAND gate 511, through the Nth gate line G_{N} of the liquid crystal panel 600, and the second gate driving signal GS₂ is applied to a second input of the NAND gate 511 through the (N−1)th gate line G_{N-1} of the liquid crystal panel 600. The NAND gate 511 generates the detection signal D_S by detecting the overlapping area of the first and second gate driving signals GS₁ and GS₂.

Referring to FIG. 5, the second gate driving signal GS₂ is applied to the second input of the NAND gate 511 and is at a logic high state for a period ranging from a time t₀ to a time t2. The first gate driving signal GS₁ is applied to the first input of the NAND gate 511 and is at a logic high state for a period ranging from a time t₁ to a time t₃. The signal generator 510 generates the detection signal D_S by detecting the overlapping area of the first and second gate driving signals GS₁ and GS₂, i.e., an area where the first and second gate driving signals GS₁ and GS₂ are both at a logic high state. The detection signal D_S is at a logic low state for a period ranging from a time t₁ to a time t₂ and at a logic high state for the remaining period of time.

While the current embodiment illustrates that a signal generator is implemented as a NAND gate by way of illustration, the invention is not limited to the illustrated example and it will be apparent to those skilled in the art that the signal generator may be implemented as any circuit known in the art so long as it can detect an overlapping area of two signals.

Referring back to FIG. 3, the detection signal D_S generated by the signal generator 510 is supplied to the input of the A/D converter 520. The A/D converter 520 performs A/D conversion on the detection signal D_S to generate a predetermined pulse width control signal OE_CONT. The pulse width control signal OE_CONT may contain information about a width of the detection signal D_S, i.e., information about a pulse width of the detection signal D_S detected during a period while the first and second gate driving signals GS₁ and GS₂ are both at a logic high state.

The generated pulse width control signal OE_CONT is fed back to the timing controller 100. Based on the pulse width control signal OE_CONT, the timing controller 100 adjusts the width of the gate output enable signal OE. In addition, the timing controller 100 defined the width of each of the gate driving signals by the width of the gate output enable signal OE and prevents the gate driving signals from overlapping each other.

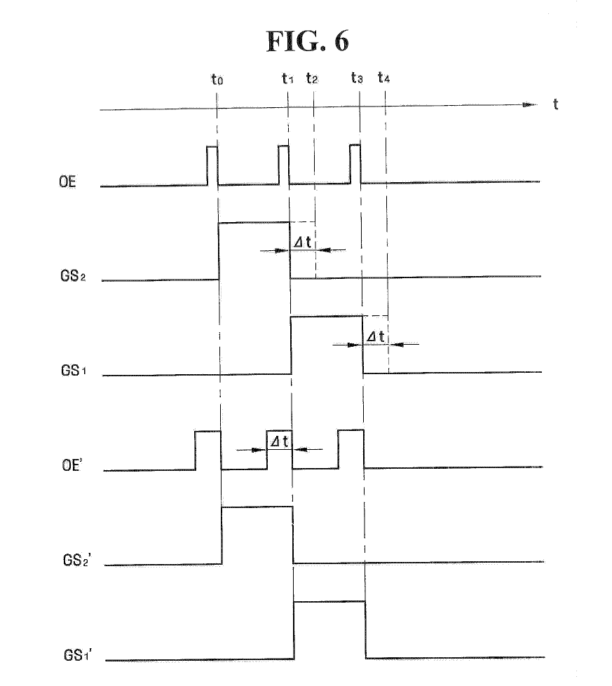

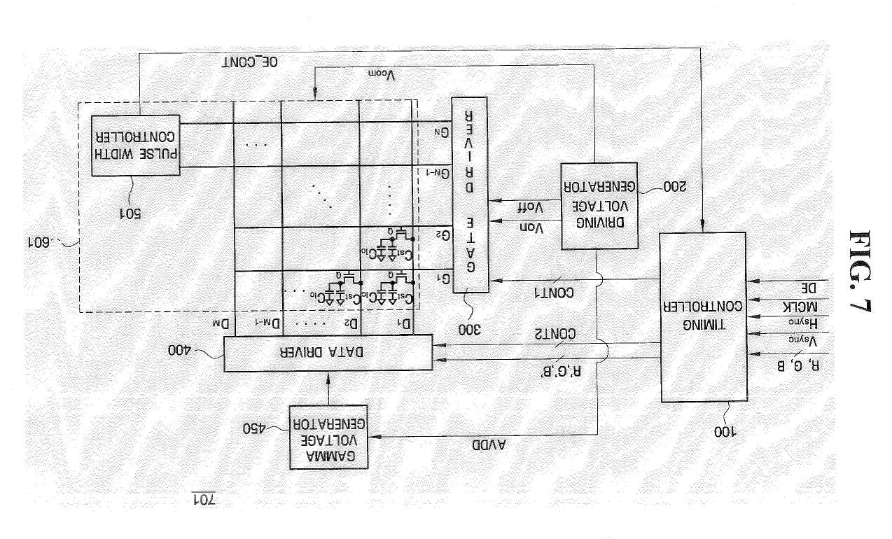

Hereinafter, the operation of the timing controller 100 will be described with regard to the pulse width controller 500 with reference to FIG. 6.

FIG. 6 is a diagram illustrating waveforms of various signals produced by the operation of the timing generator of FIG. 1.

Referring to FIG. 6, together with FIG. 1, the timing controller 100 generates the gate output enable signal OE which defines the widths of the first and second gate driving signals GS₁ and GS₂. Accordingly, the widths of the first and second gate driving signals GS₁ and GS₂ are defined by the width of the gate output enable signal OE so they do not overlap with each other.

The second gate driving signal GS₂ is a logic high state during a period t₀-t₁. In addition, the first gate driving signal GS₁ is at a logic high state during a period t₁-t₃.

Since the widths of the first and second gate driving signals GS₁ and GS₂ are defined by the width of the gate output enable signal OE, the first and second gate driving signals GS₁ and GS₂ do not overlap with each other. In addition, the gate driver 300 sequentially supplies the first and second gate driving signals GS₁ and GS₂ controlled by the gate output enable signal OE to the gate lines G₁-G_{N} of the liquid crystal panel 600.

The first gate driving signal GS₁ may be a gate driving signal supplied to the Nth gate line G_{N} disposed at the lowermost end of the liquid crystal panel 600 and the second gate driving signal GS₂ may be a gate driving signal supplied to the (N−1)th gate line G_{N-1}, i.e., a gate line adjacent to the Nth gate line G_{N}.

In addition, the first and second gate driving signals GS₁ and GS₂ are delayed for a predetermined time width Δt due to an RC delay, which is created by various wires of the liquid crystal panel 600 and the gate driver 300, while passing through the Nth and (N−1)th gate lines G_{N} and G_{N-1}. The second gate driving signal GS₂ is delayed for a predetermined time width Δt and is at a logic high state during a period t₀-t₂ and the first gate driving signal GS₁ is delayed for a predetermined time width Δt and is at a logic high state during a period t₁-t₄.

Accordingly, the pulse width controller 500 receives the first and second gate driving signals GS₁ and GS₂ delayed through the Nth and (N−1)th gate lines G_{N} and G_{N-1} and generates a predetermined pulse width control signal OE_CONT. The generated pulse width control signal OE_CONT is fed back to the timing controller 100 to adjust the width of the gate output enable signal OE. The adjusted gate output enable signal OE′ is at a logic high state for a duration of time corresponding to the overlapping area of the first and second gate driving signals GS₁ and GS₂.

The adjusted gate output enable signal OE′ is also applied to the operation of the next frame of the liquid crystal panel 600, so that the widths of first and second gate driving signals GS₁′ and GS₂′ newly supplied to the gate lines G₁-G_{N} of the liquid crystal panel 600 are defined by the width of the adjusted gate output enable signal OE′. Accordingly, the first and second gate driving signals GS₁′ and GS₂′ can be prevented from overlapping with each other.

The second gate driving signal GS₂′ that is newly supplied to the (N−1)th gate line G_{N-1} of the liquid crystal panel 600 is at a logic high state during a period t₀-t₁. The first gate driving signal GS₁′ is at a logic high state during a period t₁-t₃. Accordingly, the widths of the first and second gate driving signals GS₁′ and GS₂′ are defined by the width of the adjusted gate output enable signal OE′, so they do not overlap with each other, thereby preventing a switching error of the liquid crystal display.

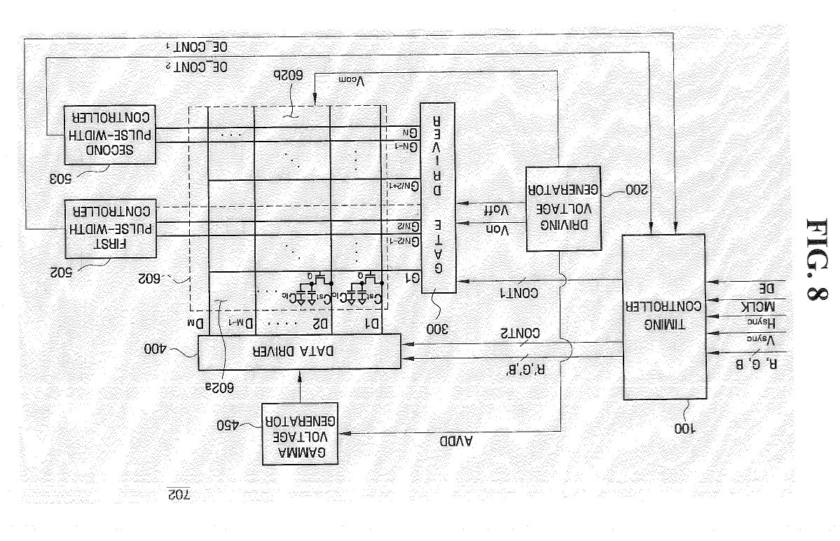

Hereinafter, an exemplary embodiment of the liquid crystal display shown in FIG. 1 will be described with reference to FIG. 7. For convenience of explanation, components each having the same function shown in FIG. 1 are respectively identified by the same reference numerals. FIG. 7 is a block diagram of a liquid crystal display (701) according to an exemplary embodiment of the present invention.

Referring to FIG. 7, the liquid crystal display 701 generally includes a liquid display panel 601, and driving apparatuses 100, 200, 300, 400, 450, and 501.

The liquid crystal panel 601 includes a plurality of unit pixels including a plurality of display signal lines G₁-G_{N} and D₁-D_{M} and a plurality of unit pixels connected to the plurality of display signal lines G₁-G_{N} and D₁-D_{M} and arranged substantially in a matrix.

The liquid crystal panel 601 may further include a pulse width controller 501 formed at a predetermined area. The pulse width controller 501 receives gate driving signals to its input terminals through two among the gate lines G₁-G_{N} and generates a predetermined control signal, e.g., the pulse width control signal OE_CONT. For example, the lowermost Nth gate line G_{N} of the liquid crystal panel 601, and the (N−1)th gate line G_{N-1}, which is adjacent to the Nth gate line G_{N}, may extend at a predetermined length to connect to the input terminals of the pulse width controller 501. The output signal of the pulse width controller 501, i.e., a pulse width control signal OE_CONT, is fed back to the timing controller 100 via a predetermined signal transmission line (not shown) disposed on the liquid crystal panel 601. The liquid crystal panel 601 may further include a signal transmission line extending parallel with an outermost data line, e.g., the Mth data line D_{M}, along one side of the liquid crystal panel 601, and the pulse width control signal OE_CONT output from the pulse width controller 501 is fed back to the timing controller 100 via the signal transmission line. The timing controller 100 adjusts the width of the gate output enable signal OE based on the feed back pulse width control signal OE_CONT and defines widths of the gate driving signals by the width of the adjusted signal OE_CONT to prevent the gate driving signals from overlapping each other.

The pulse width controller 501 may be formed at substantially the same time with the gate lines G₁-G_{N} and the data lines D₁-D_{M} of the liquid crystal panel 601.

The driving apparatuses 100, 200, 300, 400, 450, and 501 include the timing controller 100, the driving voltage generator 200, the gate driver 300, the data driver 400, the gamma voltage generator 450, and the pulse width controller 501. The pulse width controller 501 may be formed at a predetermined area of the liquid crystal panel 601.

Hereinafter, an exemplary embodiment of the liquid crystal display shown in FIG. 1 will be described with reference to FIG. 8. For convenience of explanation, components each having the same function shown in FIGS. 1 and 7 are respectively identified by the same reference numerals. FIG. 8 is a block diagram of a liquid crystal display (702), according to an exemplary embodiment of the present invention.

Referring to FIG. 8, the liquid crystal display 702 includes a liquid display panel 602, and driving apparatuses 100, 200, 300, 400, 450, 502, and 503.

The liquid crystal panel 602 includes a plurality of gate lines G₁-G_{N}, a plurality of data lines D₁-D_{M} and a unit pixel. The liquid crystal panel 602 may include at least two areas which are divided in a direction in which the plurality of gate lines G₁-G_{N} extend.

For example, the liquid crystal panel 602 may include a first area 602a and a second area 602b. The first area 602a includes first through (N/2)th gate lines G₁-G_{N/2} and the second area 602b includes [(N/2)+1]th through Nth gate lines G_{[(N/2)+1]}-G_{N}.

The (N/2)th gate line G_{N/2} disposed at the lowermost end of the first area 602a of the liquid crystal panel 602 and the [N/2)−1]th gate line G_{(N/2)-1}, i.e., a gate line which is adjacent to the (N/2)th gate line G_{N/2}, for example, may extend at a predetermined length in a direction in which the gate driving signals are transmitted. The Nth gate line G_{N} disposed at the lowermost end of the second area 602b of the liquid crystal panel 602 and the (N−1)th gate line G_{(N-1)}, i.e., a gate line which is adjacent to the Nth gate line G_{N}, for example, may also extend at a predetermined length in a direction in which the gate driving signals are transmitted.

The driving apparatuses 100, 200, 300, 400, 450, 502, and 503 include a timing controller 100, a driving voltage generator 200, a gate driver 300, a data driver 400, a gamma voltage generator 450, a first pulse width controller 502, and a second pulse width controller 503. Each of the first and second pulse width controllers 502 and 503 may include a signal generator and an A/D converter.

The configurations and operations of the timing controller 100, the driving voltage generator 200, the gate driver 300, the data driver 400, and the gamma voltage generator 450 are substantially the same as those described above with reference to FIGS. 1 and 7.

The first pulse width controller 502, which is connected to the (N/2)th gate line G_{N/2} and the [N/2)−1]th gate line G_{(N/2)-1} formed in the first area 602a of the liquid crystal panel 602, receives gate driving signals through the (N/2)th gate line G_{N/2} and the [N/2)−1]th gate line G_{(N/2)-1} and generates a first pulse width control signal OE_CONT₁. The first pulse width controller 502 generates a first detection signal by detecting an overlapping area of the two gate driving signals having passed through the (N/2)th gate line G_{N/2} and the [N/2)−1]th gate line G_{(N/2)-1}, performs an A/D conversion on the first detection signal and generates the first pulse width control signal OE_CONT₁.

The second pulse width controller 503, which is connected to the Nth gate line G_{N} and the (N−1)th gate line G_{(N-1)} formed in the second area 602b of the liquid crystal panel 602, receives gate driving signals through the Nth gate line G_{N} and the (N−1)th gate line G_{(N-1)} and generates a second pulse width control signal OE_CONT₂. Like the first pulse width controller 502, the second pulse width controller 503 generates a second detection signal by detecting an overlapping area of the two gate driving signals having passed through the Nth gate line G_{N} and the (N−1)th gate line G_{(N-1)}, performs an A/D conversion on the second detection signal and generates the second pulse width control signal OE_CONT₂.

The generated first and second pulse width control signals OE_CONT₁ and OE_CONT₂ are fed back to the timing controller 100. Based on the first and second pulse width control signals OE_CONT₁ and OE_CONT₂, the timing controller 100 adjusts the width of a gate output enable signal OE. In addition, the timing controller 100 defines the width of each of the gate driving signals by the width of the adjusted gate output enable signal OE and prevents the gate driving signals from overlapping each other.

Although the present invention has been described in connection with the exemplary embodiments of the present invention, it will be apparent to those skilled in the art that many variations and modifications can be made to thereto without substantially departing from the scope and spirit of the present invention. Therefore, the disclosed exemplary embodiments of the invention are used in a generic and descriptive sense only and not for purposes of limitation.

What is claimed is:

1. A driving apparatus comprising:
a timing controller generating a gate output enable signal having a width which is used for defining on-voltage widths of gate driving signals;
a gate driver sequentially outputting the gate driving signals corresponding to a plurality gate lines, the gate driver controlled to prevent overlapping of the gate driving signals; and
a pulse width controller comprising a signal generator receiving two of the gate driving signals from two adjacent gate lines, comparing the two gate driving signals and generating a detection signal that detects an overlapping area of the two gate driving signals and a converter converting the detection signal to a pulse width control signal and feeding the pulse width control signal back to the timing controller,
wherein the timing controller receives the pulse width control signal and adjusts the width of the gate output enable signal.

2. The driving apparatus of claim 1, wherein the converter comprises an analog-to-digital (A/D) converter.

3. The driving apparatus of claim 2, wherein the plurality of gate lines extends substantially in a row direction on the liquid crystal panel and the signal generator receives the gate driving signals through an Nth gate line of the plurality of gates lines disposed at an end of the liquid crystal panel and an (N−1)th gate line of the plurality of gate lines adjacent to the Nth gate line, respectively.

4. The driving apparatus of claim 1, wherein the signal generator detects an area where the gate driving signals are both at a logic high state on a same time axis.

5. The driving apparatus of claim 4, wherein the signal generator is implemented as a NAND gate.

6. The driving apparatus of claim 1, wherein the pulse width controller generates the pulse width control signal at lest once while the liquid crystal panel operates during one period of a frame.

7. A liquid crystal display comprising:
a liquid crystal panel having a plurality of gate lines and a plurality of data lines intersecting with each other;
a timing controller generating a gate output enable signal having a width which is used for defining on-voltage widths of gate driving signals;
a gate driver sequentially outputting the gate driving signals corresponding to a plurality of gate lines, the gate driver being controlled to prevent overlapping of the gate driving signals; and
a pulse width controller comprising a signal generator receiving two of the gate driving signals from two adjacent gate lines, comparing the two gate driving signals and generating a detection signal by detecting an overlapping area of the two gate driving signals and a converter converting the detection signal to a pulse width control signal and feeding the pulse width control signal back to the timing controller,
wherein the timing controller receives the pulse width control signal and adjusts the width of the gate output enable signal.

8. The liquid crystal display of claim 7, wherein the converter comprises an analog-to-digital (A/D) converter.

9. The liquid crystal display of claim 8, wherein the plurality of gate lines extend substantially in a row direction on the liquid crystal panel and the signal generator receives the two gate driving signals through an Nth gate line of the plurality of gate lines disposed at an end of the liquid crystal panel and an (N−1)th gate line of the plurality of gates lines adjacent to the Nth gate line.

10. The liquid crystal display of claim 8, wherein the signal generator detects an area where the two gate driving signals are both at a logic high state on a same time axis.

11. The liquid crystal display of claim 10, wherein the signal generator comprises a NAND gate.

12. The liquid crystal display of claim 7, wherein the pulse width controller generates the pulse width control signal at least once while the liquid crystal panel operates during one period of a frame.

13. A method of driving a liquid crystal display comprising:
generating a gate output enable signal having a width which is used for defining on-voltage widths of gate driving signals;
sequentially outputting the gate driving signals corresponding to a plurality of gate lines, the outputting of the gate driving signals being controlled to prevent overlapping of the gate driving signals; and
receiving two of the gate driving signals from two adjacent gate lines and generating a pulse width control signal by detecting an overlapping area of the two gate driving signals;
adjusting the width of the gate output enable signal based on the pulse width control signal.

14. The method of claim 13, wherein the two of the gate driving signals are received respectively through an Nth gate line of the plurality of gate lines disposed at an end of the liquid crystal display and an (N−1)th gate line of the plurality of gate lines adjacent to the Nth gate line.

15. The method of claim 14 further comprises generating a detection signal that detects an area where the two gate driving signals are both at a logic high state on a same time axis.

16. The method of claim 15 further comprises performing A/D conversion on the detection signal to generate the pulse width control signal.

17. The method of claim 13, wherein the pulse width control signal is generated at least once while the liquid crystal display operates during one period of a frame.
